(19) United States
(12) Patent Application Publication
(10) Pub. No.: US 2010/0058370 A1
(43) Pub. Date: Mar. 4, 2010

(54) OPTICAL PICKUP GUIDE DEVICE, METHOD FOR MANUFACTURING THE SAME, AND DISC DEVICE

(76) Inventor: Yosuke Amitani, Kanagawa (JP)

Correspondence Address: KRATZ, QUINTOS & HANSON, LLP, 1420 K Street, N.W., Suite 400, WASHINGTON, DC, 20005, US

(21) Appl. No.: 12/515,614

(22) PCT Filed: Nov. 21, 2006
(86) PCT No.: PCT/JP2006/323211

§ 371 Date: May 20, 2009

(51) Int. Cl. G11B 17/04

(52) U.S. Cl. 720/601; G9B/17.013

(57) ABSTRACT

A disc device includes. a sub-shaft; a sub-shaft support for supporting the sub-shaft; a holder body for holding an optical pickup; and a pair of engagement slide portions disposed in the holder body in a manner that the sub-shaft slide surfaces are opposed to each other. The cross section of the sub-shaft is provided in a shape other than a perfect circle with a maximum external diameter larger than the slide-surface distance and the sub-shaft is rotatably supported by the sub-shaft support.

### TECHNICAL FIELD

The present invention relates to an optical pickup guide device, a method for manufacturing the same, and a disc device.

### BACKGROUND ART

An arrangement for delivering an optical pickup has been known (see, for example, Patent Documents 1 and 2).

Patent Document 1 discloses that a plate spring is provided near a bearing portion of a slide member on which a pickup is held.

The plate spring is pressed on a sub-guide shaft to press the slide member onto the sub-guide shaft, so that a shaky movement caused by a gap between the bearing portion of the slide member and the sub-guide shaft is prevented.

Patent Document 2 discloses a biasing member including a first plate spring and a second plate spring provided at an engaging portion of a slide member on which a pickup is held. The first plate spring is resiliently brought into contact with the circumference of the sub-guide shaft at a position on a side extending in a focus direction. The second plate spring is resiliently brought into contact with the circumference of the sub-guide shaft at a position on a side extending in a direction orthogonal to the focus direction.

The first plate spring presses an abutting wall of the engaging portion toward the circumference of the sub-guide shaft, thereby preventing a shaky movement in the focus direction between the abutting wall and the sub-guide shaft. Further, the second plate spring presses the engaging portion and two bearing portions toward a circumference of a main guide shaft, thereby preventing a shaky movement in a direction parallel to a recoding surface of an optical disc between the bearing portion and the main-guide shaft.

[Patent Document 1] JP-A-2002-117634

[Patent Document 2] JP-A-2005-135463

### DISCLOSURE OF THE INVENTION

### Problems to be Solved by the Invention

However, since a plate spring is employed as a member for holding a pickup according to the arrangements of Patent Documents 1 and 2 described above, the weight and size of the arrangement of the holding member is increased, which may influence on guiding the pickup.

An object of the invention is to provide an optical pickup guide device for appropriately guiding an optical pickup, a method for manufacturing the same, and a disc device.

### Means for Solving the Problems

According to an aspect of the invention, an optical pickup guide device guides an optical pickup substantially along a radial direction of a disc-shaped recording medium held in a recording medium holder. The optical pickup guide device includes a guide including a guide member provided in a substantially stick-shaped profile; a guide support that supports the guide member of the guide; a holder body that holds the optical pickup and is movable in a guiding direction of the optical pickup in accordance with driving of a moving unit; and a pair of guide member slide portions provided in the holder body, the guide member slide portions including guide member slide surfaces that are slidably contact with a circumference of the guide member when the holder body is moved, the guide member slide surfaces substantially opposing each other through the guide member, in which the guide member is provided substantially by a stick whose cross section orthogonal to an axis exhibits a shape other than a perfect circle and has a maximum external diameter larger than distance between the substantially opposing guide member slide surfaces, the guide member being rotatably supported by the guide support around the axis between the pair of guide member slide portions.

According to an aspect of the invention, a disc device includes. a case that houses a disc-shaped recording medium; a recording medium holder that is provided on the case in a vicinity of a position where the recording medium is housed and holds the recording medium; an optical pickup; the optical pickup guide device described above that guides the optical pickup substantially along a radial direction of the recording medium held by the recording medium holder; and a moving unit that moves the holder body of the optical pickup guide device in a guiding direction of the optical pickup.

According to an aspect of the invention, a method for manufacturing an optical pickup guide device for guiding an optical pickup substantially along a radial direction of a disc-shaped recording medium held in a recording medium holder, the optical pickup guide device including. a guide including a guide member provided in a substantially stick-shaped profile; a guide support that supports the guide member of the guide; a holder body that holds the optical pickup and is movable in a guiding direction of the optical pickup in accordance with driving of a moving unit; and a pair of guide member slide portions that are provided in the holder body with the holder body is moved, the guide member slide portions including guide member slide surfaces that are in slidable contact with a circumference of the guide member when the holder body is moved, the guide member slide surfaces substantially opposing each other through the guide member, the method comprising. providing the guide member in the substantially stick-shaped profile whose cross section orthogonal to an axis exhibits a shape other than a perfect circle and has a maximum external diameter larger than distance between the substantially opposing guide member slide surfaces of the pair of the guide member slide portions; rotatably supporting around the axis between the pair of the guide member slide portions; and rotating the guide member until the guide member is not rotatable where a circumference of the guide member is abutted on the substantially opposing guide member slide surfaces.

### BRIEF DESCRIPTION OF DRAWINGS

FIG. 1 is a plan view showing an internal structure of a disc device according to a first exemplary embodiment of the invention.

FIG. 2 is a plan view showing a schematic structure of a sub-shaft portion and a sub-shaft support according to the first exemplary embodiment.

FIG. 3 is a cross section taken along III-III line in FIG. 2.

FIG. 4 is a cross section taken along IV-IV line in FIG. 2.

FIG. 5 is a cross section taken along V-V line in FIG. 3.

FIG. 6 is a cross section showing a support initial state of the sub-shaft according to the first exemplary embodiment.

FIG. 7 is a cross section showing a support end state of the sub-shaft according to the first exemplary embodiment.

FIG. 8 is an illustration seen from a circumferential side of the sub-shaft schematically showing a sub-shaft portion and a sub-shaft support according to a second exemplary embodiment of the invention.

FIG. 9 is an illustration seen from a first end of the sub-shaft schematically showing the sub-shaft portion and the sub-shaft support according to the second exemplary embodiment.

FIG. 10 is a plan view showing a schematic structure of a sub-shaft portion, a sub-shaft support and an operation member according to another embodiment of the invention.

FIG. 11 is an illustration seen from a circumferential side of the sub-shaft schematically showing a sub-shaft portion, a sub-shaft support and a biasing unit according to a still another embodiment of the invention.

FIG. 12 is a cross section taken along XII-XII line in FIG. 11.

FIG. 13 is an illustration seen from a circumferential side of the sub-shaft schematically showing a sub-shaft portion and a sub-shaft support according to a further embodiment of the invention.

FIG. 14 is an illustration seen from a first end of the sub-shaft schematically showing the sub-shaft portion and the sub-shaft support according to the further embodiment of the invention.

FIG. 15 is an illustration seen from a first end of the sub-shaft schematically showing the sub-shaft portion and the sub-shaft support according to still further embodiment of the invention.

FIG. 16 is a cross section showing a support initial state of a sub-shaft according to still further embodiment of the invention.

FIG. 17 is a cross section showing a support end state of the sub-shaft according to the above embodiment.

FIG. 18 is a cross section showing a support initial state of a sub-shaft according to still further embodiment of the invention.

FIG. 19 is a cross section showing a support end state of the sub-shaft according to the above embodiment.

FIG. 20 is a cross section showing a support initial state of a sub-shaft according to still further embodiment of the invention.

FIG. 21 is a cross section showing a support end state of the sub-shaft according to the above embodiment.

FIG. 22 is a cross section showing a support initial state of a sub-shaft according to still further embodiment of the invention.

FIG. 23 is a cross section showing a support end state of the sub-shaft according to the above embodiment.

### EXPLANATION OF CODES

100 . . . disc device
110 . . . case
230 . . . turntable serving as a recording medium holder
312,410,440,501 . . . sub-shaft portion serving as a guide of an optical pickup guide device
312A,500A,500B,500C,500D . . . sub-shaft serving as a guide member
313,450,502 . . . sub-shaft support serving as a guide support of the optical pickup guide device
314 . . . pickup moving unit serving as a moving unit
321 . . . holder body of the optical pickup guide device
324A2 . . . engagement slide portion serving as a guide member slide portion of the optical pickup guide device
324A21 . . . sub-shaft slide surfaces serving as a guide member slide surface
330 . . . optical pickup
411 . . . biasing-side end projecting portion serving as a guide end projecting portion
420,480,490 . . . sub-shaft support serving as a guide support functioning as a rotation biasing unit of the optical pickup guide device
422,463,493 . . . coil spring serving as a biasing member
425 . . . upper restricting member serving as a guide end slide member
460 . . . rotation biasing unit of the optical pickup guide device
461 . . . lateral-movement restricting member serving as the guide end slide member
462 . . . intermediate movement member
481A . . . movement restricting base serving as a guide end slide member
482 . . . plate spring serving as the biasing member
494 . . . setscrew serving as the guide end slide member
500D1 . . . round shaft member
503 . . . operation member of the optical pickup guide device

### BEST MODE FOR CARRYING OUT THE INVENTION

### First Exemplary Embodiment

A first exemplary embodiment of the invention will be described below with reference to the attached drawings.

[Arrangement of Disc Device]

A disc device according to the first exemplary embodiment of the invention will be described below with reference to the attached drawings.

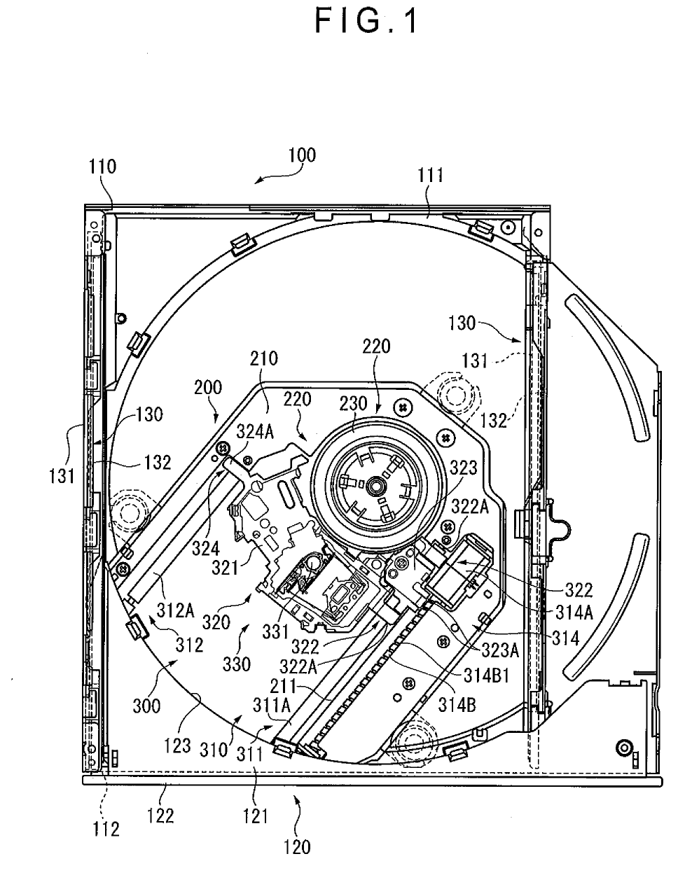

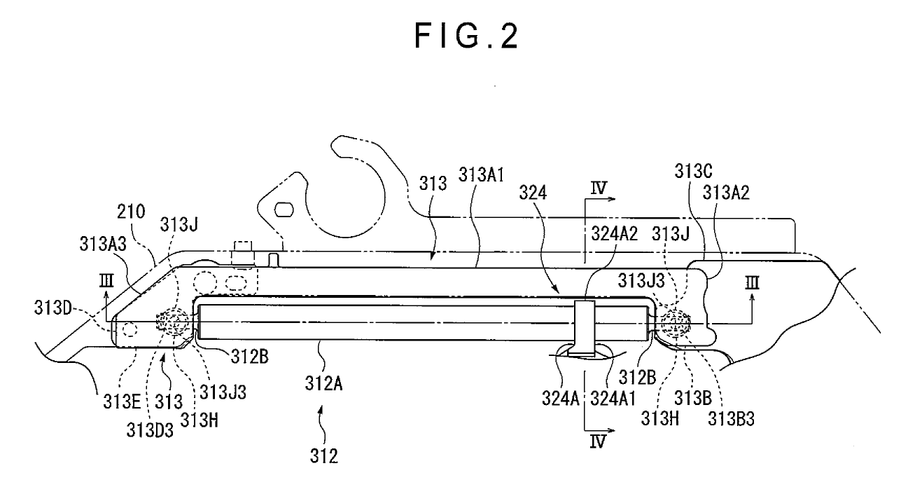

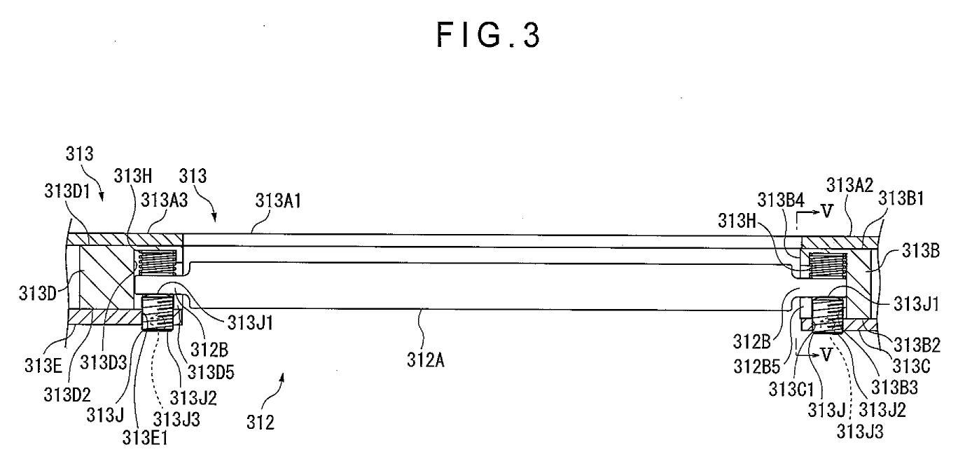

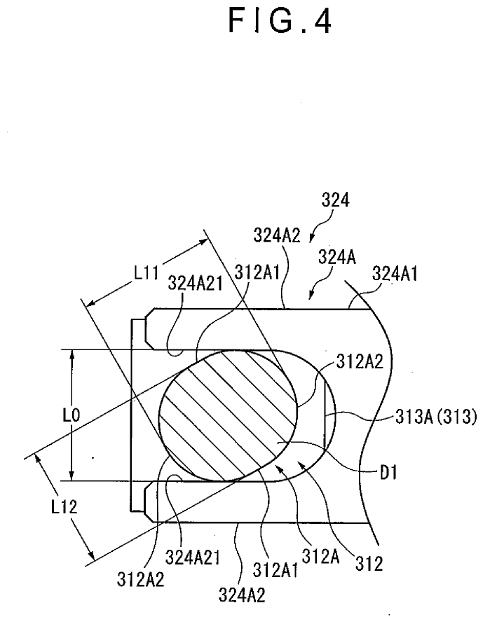

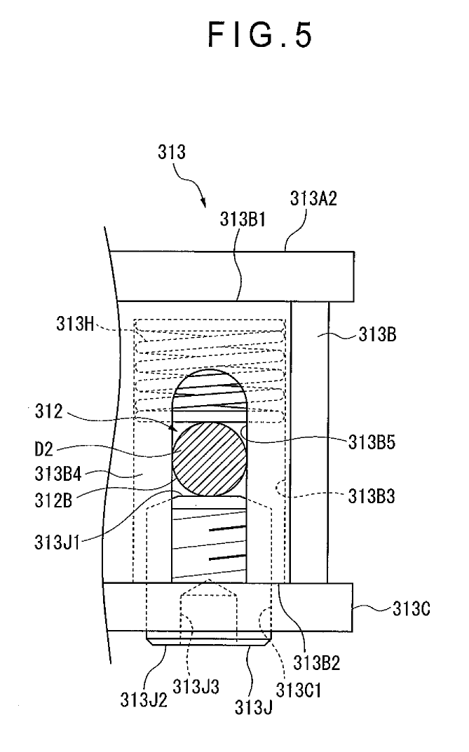

FIG. 1 is a plan view showing an internal structure of the disc device according to the first exemplary embodiment of the invention. FIG. 2 is a plan view showing a schematic structure of a sub-shaft portion and a sub-shaft support. FIG. 3 is a cross section taken along III-III line in FIG. 2. FIG. 4 is a cross section taken along IV-IV line in FIG. 2. FIG. 5 is a cross section taken along V-V line in FIG. 3.

In FIG. 1, a disc device according to the first exemplary embodiment of the invention is denoted by a reference numeral of 100. The disc device 100 is a so-called slim disc device (or slim disc drive) attached to an electric instrument such as a portable personal computer. The disc device 100 executes at least one of a reading processing (i.e. information-reading) and a recording processing (i.e. information-recording) of information recorded on a recording surface (not shown) provided on at least one surface of a detachably attached planar recording medium such as CD (Compact Disc), DVD (Digital Versatile Disc), BD (Blu-ray Disc), or HD-DVD (High Definition DVD).

The disc device 100 is provided with a case 110.

The case 110 includes a lower case 111 on a bottom side and an upper case (not shown) on a top side, the case 110 being a substantially rectangular box having a space therein. The case 110 is provided with an opening 112 on one side. In the case 110 are provided a tray portion 120, a rail portion 130 for guiding an advancing and retreating movement of the tray portion 120 through the opening 112, a lock mechanism (not shown) for locking the advancing and retreating movement of the tray portion 120 within the case 110, and a control circuit (not shown) for controlling the operation of the disc device 100.

The tray portion 120 is provided with a tray 121. The tray 121 is a plate-shaped member made of, for instance, a synthetic resin, which is adapted to be protruded and retracted through the opening 112 of the case 110.

A decorative plate 122 is provided at a first end of the tray 121 for covering the opening 112 of the case 110 when the tray 121 is housed in the case 110.

A circular recess 123 slightly larger than a diameter of an optical disc (not shown) as the recording medium is provided on a top surface of the tray 121. A disc processing section 200 is provided on the tray 121 from a first end adjacent to the decorative plate 122 substantially to a center of the circular recess 123.

The rail portion 130 is disposed from the opening 112 of the case 110 along a moving direction of the tray 121 on both sides of the tray 121. The rail portion 130 includes. a pair of rails 131 fixed on the case 110; and rail guides 132 slidably provided on the tray 121.

The rails 131 extend from both lateral ends of the opening 112 toward the innermost of the case 110. The rails 131 are provided with grooves each having a substantially C-shaped cross section, the grooves opening toward each other and slidably supporting the rail guides 132. Each of the rails 131 is provided with a slide restricting portion (not shown) for restricting a slidable range of the rail guide 132. Specifically, the slide restricting portion of the rail 131 prevents the rail guide 132 from derailing from the groove when the rail guide 132 moves toward the opening 112.

The rail guides 132 are respectively provided on the both sides of the tray 121 and are slidably held in the grooves of the rails 131 as described above. The rail guides 132 are also attached in a manner to slidably contact with the tray 121. The tray 121 is provided with a slide restricting portion (not shown) for restricting a slidable range of the rail guide 132, thereby preventing the tray 121 from derailing from the rail guides 132.

The disc processing section 200 provided on the tray portion 120 includes a base 210 that is a substantially plate-shaped member made of metal and the like, a first end of the base 210 being swingably supported by the tray 121. The base 210 is elongated from a first end of the tray 121 adjacent to the decorative plate 122 toward a center of the tray 121. An elongated processor opening 211 is cut out substantially at the center of the base 210 along a longitudinal direction. A disc rotation driver 220 is disposed at a first end of the processor opening 211 of the base 210.

The disc rotation driver 220 includes. a spindle motor (not shown); and a turntable 230 that is integrated with an output shaft of the spindle motor, the turntable 230 functioning as a recording medium holder. The spindle motor is controllably connected with the control circuit to be driven by electricity supplied from the control circuit. The turntable 230 is provided substantially at the center of the tray 121 and rotatably holds the optical disc.

An information processing section 300 is provided on the base 210. The information processing section 300 includes. a processor moving portion 310; a pickup holder 320; and an optical pickup 330.

The processor moving portion 310 includes. a main shaft portion 311; main shaft supports (not shown); a sub-shaft portion 312 as a guide, a sub-shaft support 313 (see FIG. 2) as a guide support; and a pickup moving unit 314 as a moving unit.

The main shaft portion 311 includes a main shaft 311A.

The main shaft 311A is a round stick member made of, for example, stainless.

The main shaft supports are correspondingly positioned on both longitudinal ends of the main shaft 311A of the base 210, the main shaft supports supporting the main shaft 311A in a manner that the main shaft 311A is axially aligned with a moving direction of the pickup holder 320.

As shown in FIGS. 1 to 3, the sub-shaft portion 312 includes. a sub-shaft 312A as a guide member; and a pair of sub-shaft end projecting portions 312B.

The sub-shaft 312A is a stick made of, for example, stainless, that has an ellipsoidal cross section D1 orthogonal to an axial direction of the sub-shaft 312A, and the cross section D1 having a maximum external diameter L11 larger than a distance L0 between sub-shaft slide surfaces 324A21 (referred to as a slide-surface distance L0 hereinafter) described below and a minimum external diameter L12 smaller than the slide-surface distance L0, as shown in FIG. 4. Specifically, the cross section D1 of the sub-shaft 312A is provided by a pair of straight portions 312A1 opposing with each other and a pair of semicircular portions 312A2 opposing each other at both ends of the straight portions 312A1. The maximum external diameter L11, which is a distance between midpoints of arcs of the pair of semicircular portions 312A2, is larger than the slide-surface distance L0, and the minimum external diameter L12, which is a distance between the pair of straight portions 312A1, is smaller than the slide-surface distance L0.

As shown in FIGS. 2, 3 and 5, the sub-shaft end projecting portions 312B are shaped in a round stick whose cross section D2 orthogonal to an axis is circular, the sub-shaft end projecting portions 312B projecting from both axial ends of the sub-shaft 312A.

The sub-shaft support 313 includes a support base 313A that is a substantially C-shaped plate member and is provided on the base 210. The support base 313A includes. a substantially rectangular plate-shaped longitudinal portion 313A1; a first projection 313A2 projecting outward from a longitudinal first end of the longitudinal portion 313A1; a second projection 313A3 projecting in the same direction as the first projection 313A2, thereby providing a substantially square C-shaped profile.

A first support 313B of a substantially square block is provided on a side of the first projection 313A2. A spring fitting groove 313B3 is provided in the first support 313B, the spring fitting groove 313B3 extending from a second attachment surface 313B2 opposite to a first attachment surface 313B1 attached to the first projection 313A2 toward a vicinity of the first attachment surface 313B1. A coil spring 313H is fitted into the spring fitting groove 313B3 to be positioned adjacent to the first attachment surface 313B1.

A shaft engagement opening 313B5 is provided on a lateral surface 313B4 of the first support 313B adjacent to the second projection 313A3, the shaft engagement opening 315B5 extending from the second attachment surface 313B2 toward a vicinity of the first attachment surface 313B1. The shaft engagement opening 313B5 has a width slightly larger than a diameter of the sub-shaft end projecting portion 312B. The sub-shaft end projecting portion 312B3 is engaged with the shaft engagement opening 313B5 so that the sub-shaft end projecting portion 312B is abutted on a side of the coil spring 313H facing the second attachment surface 313B2.

A plate-shaped first screw attachment portion 313C is provided on the second attachment surface 313B2 of the first support 313B. A screw hole 313C1 is provided on the first screw attachment portion 313C. The first screw attachment portion 313C is attached to, for example, the base 210 in such a manner that a center of the screw hole 313C1 substantially is aligned with a center of the spring fitting groove 313B3.

A setscrew 313J is screwed in the screw hole 313C1 in such a manner that a tip-end 313J1 of the setscrew 313J is abutted on the sub-shaft end projecting portion 312B. A wrench engagement groove 313J3 to be engaged with, for example, a hexagonal wrench is provided on a base end surface 313J2 of the setscrew 313J.

A second support 313D (a substantially square block) arranged substantially in the same manner as the first support 313B is provided on a surface of the second projection 313A3. A first attachment surface 313D1 of the second support 313D is attached to the second projection 313A3. The second support 313D is also provided with a spring fitting groove 313D3 where the coil spring 313H is fitted and a shaft engagement opening 313D5 where the sub-shaft end projecting portion 312B is engaged.

A plate-shaped second screw attachment portion 313E is provided on a second attachment surface 313D2 of the second support 313D. the second screw attachment portion 313E is provided with a screw hole 313E1 to which a setscrew 313J1 is screwed. The second screw attachment portion 313E is provided on, for example, the second support 313D in such a manner that a center of the screw hole 313E1 is substantially aligned with a center of the spring fitting groove 313D3.

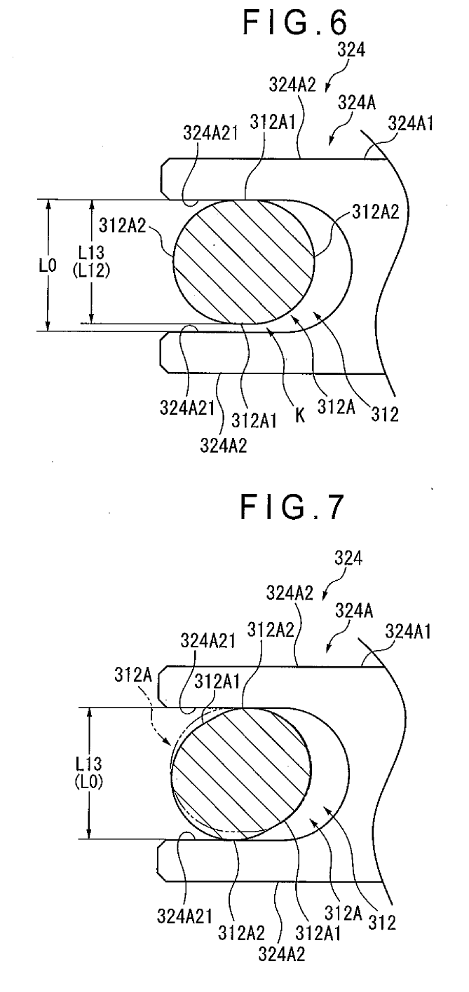

The sub-shaft support 313 rotatably supports the sub-shaft 312A around an axis thereof when the sub-shaft end projecting portions 312B are held between the setscrews 313J and the coil springs 313H. Specifically, the sub-shaft support 313 supports the sub-shaft 312A according to a support initial state where a gap K (see FIG. 6) is provided between the sub-shaft 312A and the sub-shaft slide surfaces 324A21, and in a support end state where the gap K is eliminated to avoid a shaky movement in a direction orthogonal to a moving direction of the pickup holder 320 (i.e. a vertical direction in FIG. 4) as shown in FIGS. 4 and 7 which will be described below.

The sub-shaft support 313 also supports the sub-shaft 312A in such a manner that an axial direction of the sub-shaft 312A is parallel to that of the main shaft 311A.

In addition, the position of the sub-shaft end projecting portions 312B supported by the first and second supports 313B and 313D is adjusted by a screwing condition of the setscrews 313J and biasing of the coil springs 313H according to an inclination and the like of the turntable 230 and the optical pickup 330, thereby adjusting the axial direction of the sub-shaft 312A.

As shown in FIG. 1, the pick moving unit 314 is provided with an electric motor 314A in which a lead screw 314B having a spiral engagement groove 314B1 on an outer circumference thereof is attached to a motor shaft (not shown). The lead screw 314B is provided in the vicinity of the main shaft 311A on a side remote from the sub-shaft 312A and in such a manner that the lead screw 314B is axially parallel to the main shaft 311A.

The pickup holder 320 is provided with a holder body 321 that is a substantially rectangular plate member that bridges the main shaft 311A and the sub-shaft 312A. Two main shaft housing portions 322 having a shaft housing hole 322A in which the main shaft 311A can be inserted and a movement restricting portion 323 having two restricting claws 323A to be engaged with the engagement groove 314B1 of the lead screw 314B are provided at a first longitudinal end of the holder body 321. A sub-shaft housing portion 324 is provided at a second longitudinal end of the holder body 321.

As shown in FIGS. 2 and 4, the sub-shaft housing portion 324 includes a shaft engagement portion 324A having a C-shaped cross section where the sub-shaft 312A can be engaged. The shaft engagement portion 324A includes. an engagement base portion 324A1 fixed to the holder body 321; and a pair of engagement slide portions 324A2 (guide-member slide portions) that project from the engagement base portion 324A1 in an out-of-plane direction of the holder body 321, the shaft engagement portion 324A exhibiting a C-shaped cross section by the above components. As shown in FIG. 4, facing surfaces of the engagement slide portions 324A2 are the sub-shaft slide surfaces 324A21 serving as guide-member slide surfaces. The engagement slide portions 324A2 are provided in such a manner that the sub-shaft slide surfaces 324A21 are parallel to each other and are remote from each other by the slide-surface distance L0.

The optical pickup guide device of the invention is provided by the sub-shaft portion 312, the sub-shaft support 313, the holder body 321 and the engagement slide portions 324A2.

The optical pickup 330 includes. a light source (not shown); a pickup lens 331; and an optical sensor, each component being provided substantially at the center of the holder body 321 in a manner facing an optical disc.

The control circuit controls an operation of the disc processing section 200, thereby, for example, allowing the information processing section 300 to carry out information reading processing and information writing processing of the optical disc. The control circuit also controls a rotating operation of the turntable 230, a moving operation of the information processing section 300, an operation of the base 210 and the like. The control circuit also outputs an eject instruction signal inputted from an eject button provided on the decorative plate 122.

[Method for Manufacturing Processor Moving Portion]

Next, a method for manufacturing the processor moving portion 310 of the disc device 100 will be described.

FIG. 6 is a cross section showing a support initial state of the sub-shaft. FIG. 7 is a cross section showing a support end state of the sub-shaft.

Initially, an operator carries out a predetermined operation to insert the main shaft 311A into the shaft housing hole 322A and engage the restricting claws 323A with the engagement grooves 314B1 of the lead screw 314B. Then, the operator attaches the main shaft portion 311, the main shaft support, the pickup moving unit 314 and the like to the base 210. The sub-shaft end projecting portion 312B is supported by the sub-shaft support 313.

In a state where surfaces corresponding to the straight portions 312A1 face the sub-shaft slide surfaces 324A21, the sub-shaft 312A is engaged with the shaft engagement portion 324A and the sub-shaft support 313 is attached to the base 210. Thus, the part of the minimum external diameter L12 is opposed to the sub-shaft slide surfaces 324A21, in other words, a distance L13 between a pair of opposing parts of the sub-shaft 312A (referred to as an opposing part-distance L13 hereinafter) is equalized to the minimum external diameter L12, whereby the sub-shaft 312A is more easily engaged.

Subsequently, when the operator releases the sub-shaft 312A, one of the surfaces of the sub-shaft 312A corresponding to the straight portions 312A1 and the sub-shaft slide surface of the engagement slide portion 324A2 located above are abutted to each other to provide the gap K beneath the sub-shaft 312A as shown in FIG. 6 (support initial state). At this time, the sub-shaft 312A is rotatably supported by the sub-shaft support 313. Under the support initial state, the opposing part-distance L13 is equal to the minimum external diameter L12 as described above.

Subsequently, when the operator rotates the sub-shaft 312A, a portion of the sub-shaft 312A abutted on the sub-shaft slide surfaces 324A21 is moved from the straight portion 312A1 to the semicircular portion 312A2, whereby the opposing part-distance L13 becomes longer than that in the support initial state. As the opposing part-distance L13 becomes longer, the gap K becomes smaller.

As shown in FIG. 7, when the sub-shaft 312A is further rotated to equalize the opposing part-distance L13 to the slide surface distance L0, i.e., the circumference of the sub-shaft 312A is abutted on the pair of the sub-shaft slide surfaces 324A21 so that the sub-shaft 312A cannot be further rotated, the gap K is eliminated (the support end state), thus finishing the manufacture of the processor moving portion 310.

### Advantages of First Exemplary Embodiment

As described above, in the first exemplary embodiment, the disc device 100 includes. the sub-shaft 312A; the sub-shaft support 313 for supporting the sub-shaft 312A; the holder body 321 for holding the optical pickup 330; and a pair of engagement slide portions 324A2 provided in the holder body 321 in such a manner that the sub-shaft slide surfaces 324A21 are opposed to each other. Further, the cross section D1 of the sub-shaft 312A is formed substantially in an ellipsoidal shape, i.e. in non-perfect circular shapes, and with a maximum external diameter L11 larger than the slide-surface distance L0. The sub-shaft 312A is rotatably supported by the sub-shaft support 313.

As described above, after the sub-shaft 312A is engaged with the shaft engagement portion 324A while retaining the gap K against the sub-shaft slide surface 324A21, the sub-shaft 312A is rotated until the sub-shaft 312A is no longer rotatable to eliminate the gap K. Accordingly, the holder body 321 for holding the optical pickup 330 does not require any dedicated component as in typical devices in order to avoid the shaky movement in the direction orthogonal to the moving direction of the pickup holder 320, so that the weight and size of the pickup holder 320 are not increased. Consequently the optical pickup 330 can be appropriately guided without being influenced.

Since the disc device 100 is arranged so as to appropriately guide the optical pickup 330 as described above, a distance between the pickup lens 331 and the optical disc can be appropriately kept and an appropriate information processing can be carried out.

### Second Exemplary Embodiment

A second exemplary embodiment of the invention will be described below with reference to the attached drawings.

[Arrangement of Sub-Shaft Portion and Sub-Shaft Support]

The second exemplary embodiment will be explained with reference to a sub-shaft portion and a sub-shaft support applicable to the disc device 100 described in the first exemplary embodiment. Incidentally, the same components as those in the first exemplary embodiment are indicated by the same names or numerals for omitting the detailed description thereof.

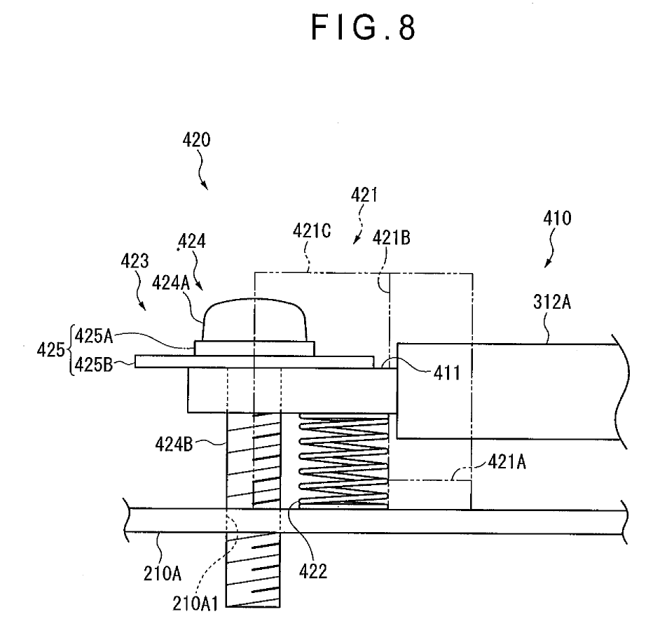

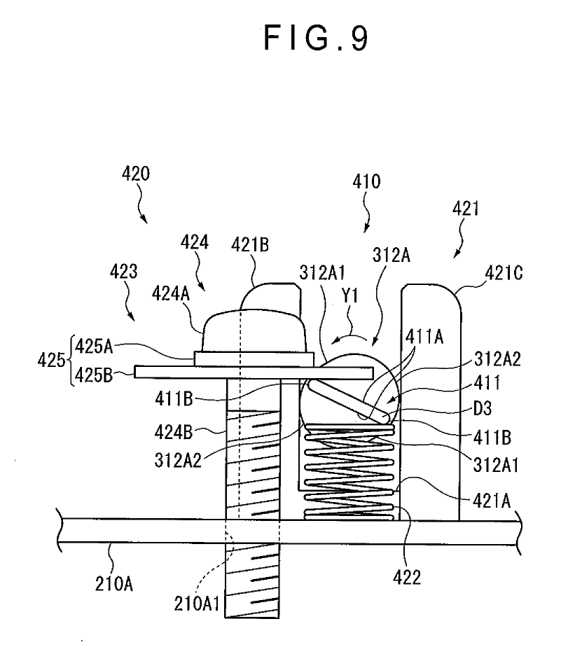

FIG. 8 is an illustration seen from a circumferential side of the sub-shaft schematically showing the sub-shaft portion and the sub-shaft support according to the second exemplary embodiment of the invention. FIG. 9 is an illustration seen from a first end of the sub-shaft schematically showing the sub-shaft portion and the sub-shaft support.

A sub-shaft portion 410 as a guide of the optical pickup guide device and a sub-shaft support 420 as a guide support functioning also a rotation biasing unit of the optical pickup guide device as shown in FIGS. 8 and 9 are applied instead of the sub-shaft portion 312 and the sub-shaft support 313 in the first exemplary embodiment as described above.

The sub-shaft portion 410 includes. the sub-shaft 312A; the sub-shaft end projecting portion 312B (not shown) projecting from a first axial end of the sub-shaft 312A; and a biasing-side end projecting portion 411 projecting from a second axial end of the sub-shaft 312A.

As shown in FIG. 9, the biasing-side end projecting portion 411 is provided with a substantially thin rectangular surface D3 that is orthogonal to an axis of the sub-shaft 312A. Specifically, the surface D3 of the biasing-side end projecting portion 411 is provided substantially in a long rectangle by a pair of straight portions 411A opposing each other and a pair of semicircular portions 411B opposing each other on both ends of the straight portions 411A. The biasing-side end projecting portion 411 is provided in such a manner that extending directions of the straight portions 411A and the straight portions 312A1 of the sub-shaft 312A are intersected with each other.

The sub-shaft support 420 includes. a support body (not shown) for rotatably supporting the sub-shaft end projecting portion 312B; a lateral-movement restricting member 421; a coil spring 422 as a biasing member; and an upper movement restricting portion 423.

The lateral-movement restricting member 421 includes. a rectangular plate-shaped movement restricting base 421A; a first movement restricting side 421B projecting from a first side of the movement restricting base 421A in a direction orthogonal to a surface direction thereof; and a second movement restricting side 421C projecting from a second side of the movement restricting base 421A in the same direction as the first movement restricting side 421B, the lateral-movement restricting member 421 being cross-sectionally square C-shaped by the aforementioned components.

The first movement restricting side 421B is a rectangular plate member having a width equal to that of the movement restricting base 421A. The second movement restricting side 421C is a rectangular plate member having a width longer than that of the movement restricting base 421A.

The movement restricting base 421A of the lateral-movement restricting member 421 is fixed by on a plate-like attachment portion 210A integrated with the base 210. Specifically, the lateral-movement restricting member 421 is fixed in such a manner that the sub-shaft 312A is surrounded only by the movement restricting base 421A and the first and second movement restricting sides 421B and 421C and that the biasing-side end projecting portion 411 is singularly located at a position opposing the second movement restricting side 421C.

The coil spring 422 is provided at a position opposing the second movement restricting side 421C of the lateral-movement restricting member 421 and under the to biasing-side end projecting portion 411 in such a manner that an expanding direction is substantially orthogonal to a surface of the movement restricting base 421A.

The upper movement restricting portion 423 includes a screw member 424, and an upper restricting member 425 as a guide end slide member.

The screw member 424 includes. a screw head 424A having a driver engagement groove in which a driver (not shown) can be engaged; and a screw shaft 424B screwed into a screw hole 210A1 of the attachment portion 210A.

The upper restricting member 425 includes a disc-shaped restricting member base 425A having an insert hole (not shown) substantially at a center into which the screw shaft 424B can be inserted. A radially projecting flange 425B is provided on a periphery of a first axial end of the restricting member base 425A. The upper restricting member 425 is attached by inserting the screw shaft 424B into the insert hole while the flange 425B is located above the biasing-side end projecting portion 411 and screwing the screw shaft 424B into the screw hole 210A1.

[Operation of Sub-Shaft Portion and Sub-Shaft Support]

Next, operations of the sub-shaft portion 410 and the sub-shaft support 420 will be described.

the sub-shaft portion 410 is rotatably supported by the sub-shaft support 420 by engaging the sub-shaft end projecting portion 312B with a shaft end engagement groove (not shown) of the support body so that the sub-shaft 312A is located at a position surrounded in the C-shaped portion of the side movement restricting member 421 and the biasing-side end projecting portion 411 is disposed between the coil spring 422 and the upper restricting member 425. At this time, a first semicircular portion 411B of the biasing-side end projecting portion 411 is abutted on the coil spring 422 and a second semicircular portion 411B of the biasing-side end projecting portion 411 is abutted on the upper restricting member 425.

Thus, when the sub-shaft portion 410 is supported by the sub-shaft support 420, the first semicircular portion 411B is biased to be moved upward by the coil spring 422. When the first semicircular portion 411B is further moved upward, the second semicircular portion 411B is slidably abutted on the upper restricting member 425 and is simultaneously moved toward the screw member 424, whereby the biasing-side end projecting portion 411 and the sub-shaft 312A start to rotate in a direction of Y1 (shown by an arrow in FIG. 9) and keep rotating until the circumference of the sub-shaft 312A is abutted on a pair of the sub-shaft slide surfaces 324A21 (the support end state).

### Advantages of Second Exemplary Embodiment

As described above, the second exemplary embodiment can provide the following advantages in addition to the advantages of the first exemplary embodiment.

The sub-shaft support 420 is provided with a biasing function to rotate the sub-shaft 312A.

Accordingly, the operator does not need to rotate the sub-shaft 312A until the support end state, thereby improving the productivity of the disc device 100. Further, for example, even if the sub-shaft 312A is worn away due to a long-time use of the disc device 100, the support end state can be maintained by automatically rotating the sub-shaft 312A to compensate for the abrasion. Consequently, as compared with the arrangement of the first exemplary embodiment, a frequency for adjusting the disc device 100 during a long time use can be reduced.

The sub-shaft 312A is provided with the biasing-side end projecting portion 411 in which the surface D3 orthogonal to the axis of the sub-shaft 312A is provided in non-perfect circular shapes. Additionally, the sub-shaft support 420 is provided with the upper restricting member 425 above the biasing-side end projecting portion 411 and the coil spring 422 under the biasing-side end projecting portion 411.

Accordingly, the biasing-side end projecting portion 411 is biased upward by the coil spring 422 and is slidably abutted on the upper restricting member 425 to rotate the sub-shaft 312A in a direction of Y1 (an arrow) until the support end state. Consequently, with a simple arrangement to bias the biasing-side end projecting portion 411 in one direction, the sub-shaft 312A can be rotated.

Further, the coil spring 422 is used for upwardly biasing the biasing-side end projecting portion 411.

Accordingly, the manufacturing cost can be minimized by using the easily available and inexpensive coil spring 422.

### Modifications of Exemplary Embodiments

It should be noted that the invention is not limited to the first and second exemplary embodiments described above, but may include modifications described below within a scope where an object of the invention can be achieved.

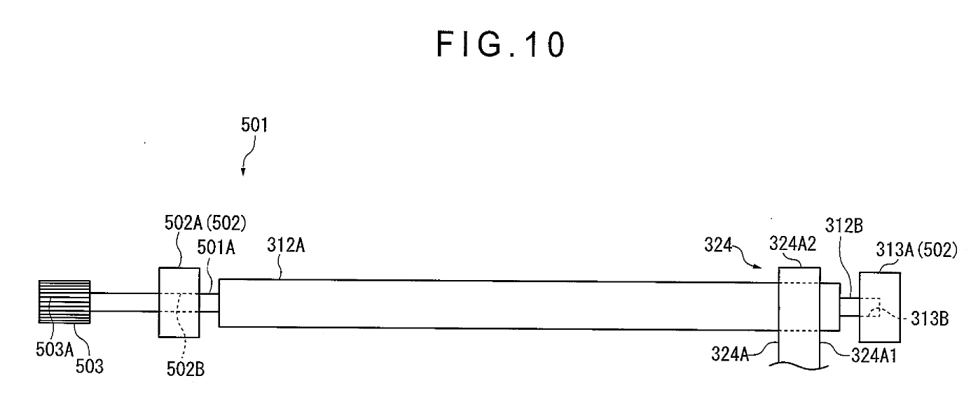

An arrangement shown in FIG. 10 may be used instead of the sub-shaft 312A and the sub-shaft support 313 of the first exemplary embodiment.

In the arrangement shown in FIG. 10, a sub-shaft portion 501 includes. the sub-shaft 312A; the sub-shaft end projecting portion 312B projecting from a first axial end of the sub-shaft 312A; and an operation-side end projecting portion 501A projecting from a second axial end of the sub-shaft 312A. The operation-side end projecting portion 501A is a round stick member longer than the sub-shaft end projecting portion 312B.

A sub-shaft support 502 as a guide support of the optical pickup guide device includes. the single support body 313A; and a substantially rectangular box-shaped single operation-side support body 502A. A shaft-end insert hole 502B where the operation-side end projecting portion 501A can be inserted is provided substantially at a center of the operation-side support body 502A.

A sub-shaft end projecting portion 312B is engaged with the shaft end engagement groove 313B and the operation-side end projecting portion 501A is inserted in the shaft-end insert hole 502B, whereby the sub-shaft portion 501 can be rotatably supported by the sub-shaft support 502. A tip end of the operation-side end projecting portion 501A is projected from the rest of the operation-side end projecting portion 501A. A substantially cylindrical operation member 503 provided in the optical pickup guide device is integrally provided on the projecting tip-end, the operation member 503 being provided with grooves 503A on a circumference thereof.

According to this arrangement, the operation member 503 is operated to rotate the sub-shaft 312A, thereby facilitating a shift operation from the support initial state to the support end state.

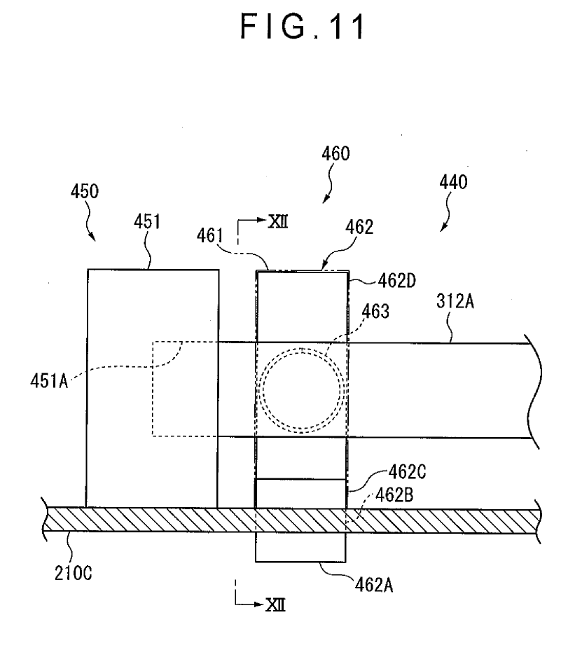

Alternatively, such an arrangement as shown in FIGS. 11 and 12 may be applied instead of the sub-shaft portion 410 and the sub-shaft support 420 of the second exemplary embodiment.

A sub-shaft portion 440 as a guide member of the optical pickup guide device as shown in FIGS. 11 and 12 is provided only by the sub-shaft 312A.

A sub-shaft support 450 as a guide support of the optical pickup guide device includes a pair of support bodies 451 (only one shown) substantially like a rectangular box. A shaft-end engagement groove 451A is provided substantially at the center of a first surface of the support body 451 in such a manner that the sub-shaft 312A is rotatably engaged with the shaft-end engagement groove 451A.

A rotation biasing unit 460 of the optical pickup guide device includes. a lateral-movement restricting member 461 (not shown in FIG. 11) as a guide-end slide member; an intermediate movement member 462; and a coil spring 463 as a biasing member. The base 210 provided with the rotation biasing unit 460 is provided with a wall 210B vertically mounted and a plate-shaped attachment portion 210C horizontally extending from a bottom of the wall 210B. The wall 210B is provided with a spring accommodation portion 210D projecting in the same direction as the attachment portion 210C. The attachment portion 210C is provided with a slit 210E having larger width than that of an intermediate engagement portion 462B (described below).

The biasing-side end projecting portion 461 is a substantially rectangular plate-shaped member that is vertically fixed on the attachment portion 210C.

The intermediate movement member 462 includes an intermediate base 462A that is substantially a rectangular plate-shaped. An intermediate engagement portion 462B projecting upward is integrally provided substantially at a center of a first surface of the intermediate base 462A. A projecting portion 462C shaped in a substantially rectangular plate larger than the intermediate base 462A is integrally provided at a tip-end of the intermediate engagement portion 462B in the projecting direction in such a manner that a surface direction of the projecting portion 462C is parallel to that of the intermediate base 462A. A substantially rectangular plate-shaped intermediate abutment portion 462D is vertically integrated on the projecting portion 462C at a position corresponding to the intermediate engagement portion 462B in such a manner that a first surface of the intermediate abutment portion 462D faces the lateral-movement restricting member 461.

The intermediate engagement portion 462B is engaged with the slit 210E and a periphery of the slit 210E is positioned between the intermediate base 462A and the projecting portion 462C, whereby the intermediate abutment portion 462D opposes the lateral-movement restricting member 461 and the intermediate movement member 462 moves toward and away from the lateral-movement restricting member 461.

The coil spring 463 is provided on the spring accommodation portion 210D in such a manner that an expanding/contracting direction of the coil spring 463 coincides with the moving direction of the intermediate movement member 462.

Both ends of the sub-shaft 312A are engaged with the shaft-end engagement groove 451A, whereby the sub-shaft portion 440 is rotatably supported by the sub-shaft support 450. At this time, the first semicircular portion 312A2 is abutted on the lateral-movement restricting member 461, the second semicircular portion 312A2 is abutted on the intermediate movement member 462 and the sub-shaft 312A is biased toward the lateral-movement restricting member 461 by the coil spring 463.

Thus, once the sub-shaft portion 440 is biased by the rotation biasing unit 460, while the pair of the semicircular portions 312A2 are slidably abutted on the lateral-movement restricting member 461 and the intermediate movement member 462, the sub-shaft portion 440 starts rotating in a direction of Y2 (shown by a arrow in FIG. 12) and keeps being rotated until the circumference of the sub-shaft 312A is abutted on the pair of the sub-shaft slide surfaces 324A21 (the support end state).

Even with this arrangement, the same advantages as those of the second exemplary embodiment described above can be obtained. Further, since the sub-shaft 312A is biased by the coil spring 463 through the intermediate movement member 462, damage on the sub-shaft 312A can be avoided as compared with the arrangement that the sub-shaft 312A is in contact by the coil spring 463 to be biased.

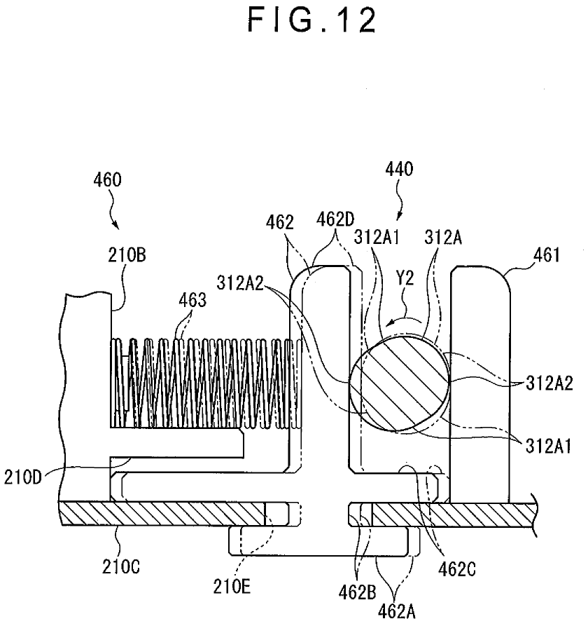

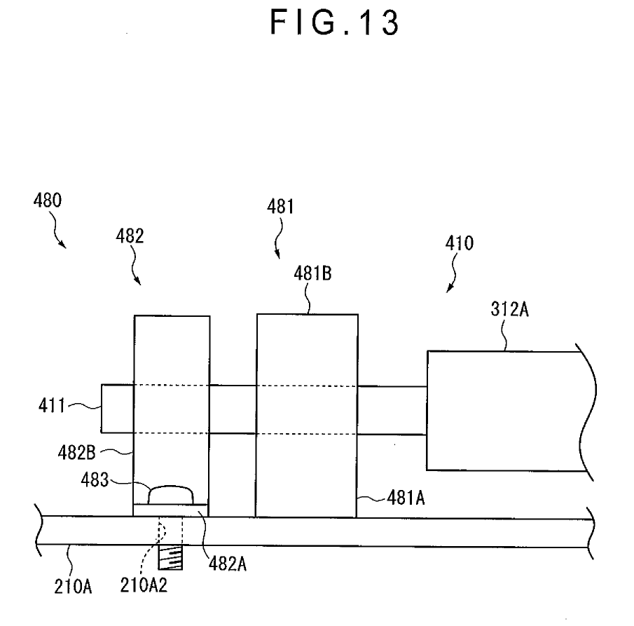

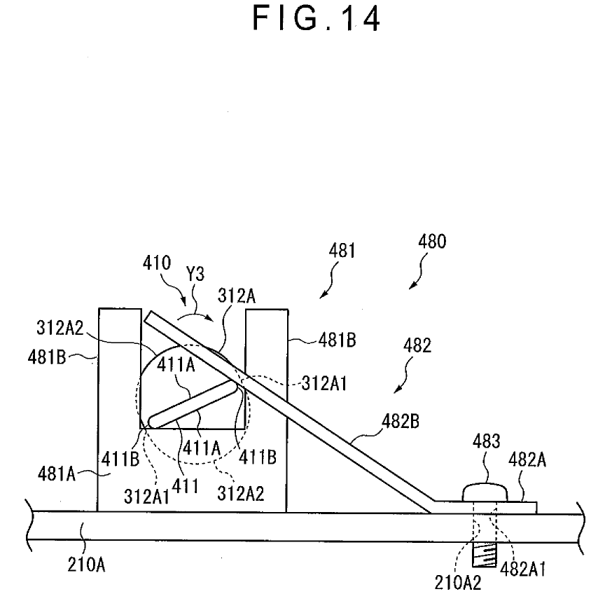

Alternatively, such an arrangement as shown in FIGS. 13 and 14 may be applied instead of the sub-shaft support 420 of the second exemplary embodiment.

A sub-shaft support 480 as a guide support functioning as the rotation biasing unit of the optical pickup guide device includes. a single support body 313A (not shown); a lateral-movement restricting member 481; and a plate spring 482 as a biasing member.

The lateral-movement restricting member 481 includes a movement restricting member 481A shaped like a rectangular plate (guide end slide member); and a pair of movement restricting sides 481B projecting from both ends of the movement restricting member 481A in a direction orthogonal to a surface direction, thus exhibiting a C-shaped cross section. The lateral-movement restricting member 481 is fixed on the attachment portion 210A by the movement restricting base 481A in such a manner that the biasing-side end projecting portion 411 is surrounded by the movement restricting base 481A and the pair of the movement restricting sides 481B.

The spring plate 482 includes. a rectangular plate-shaped plate spring attachment portion 482A having an insert hole 482A1 for the screw member 483 to be inserted substantially at the center thereof; and a plate spring biasing portion 482B extending obliquely upward from a first side of the plate spring attachment portion 482A. While the plate spring biasing portion 482B is positioned above the biasing-side end projecting portion 411, the screw member 483 is inserted into the insert hole 482A1 to be screwed with a screw hole 210A2 of the attachment portion 210A, whereby the spring plate 482 is attached.

The sub-shaft end projecting portion 312B is engaged with the support body 313A (not shown) and the biasing-side end projecting portion 411 is positioned between the movement restricting base 481A and the spring plate 482, whereby the sub-shaft portion 410 is rotatably supported by the sub-shaft support 480. At this time, the first semicircular portion 411B of the biasing-side end projecting portion 411 is abutted on the spring plate 482 and the second semicircular portion 411B is abutted on the movement restricting base 481A.

Thus, when the sub-shaft portion 410 is supported by the sub-shaft support 480, the first semicircular portion 411B is biased to be moved downward by the spring plate 482. When the first semicircular portion 411B is further moved downward, the second semicircular portion 411B is moved away from the plate spring attachment portion 482A while being slidably abutted on the movement restricting base 481A, whereby the biasing-side end projecting portion 411 and the sub-shaft 312A start rotating in a direction of Y3 (shown by an arrow in FIG. 14) and keep rotating until the circumference of the sub-shaft 312A is abutted on the pair of the sub-shaft slide surfaces 324A21 (the support end state where).

Even with this arrangement, the same advantages as those of the second exemplary embodiment described above can be obtained.

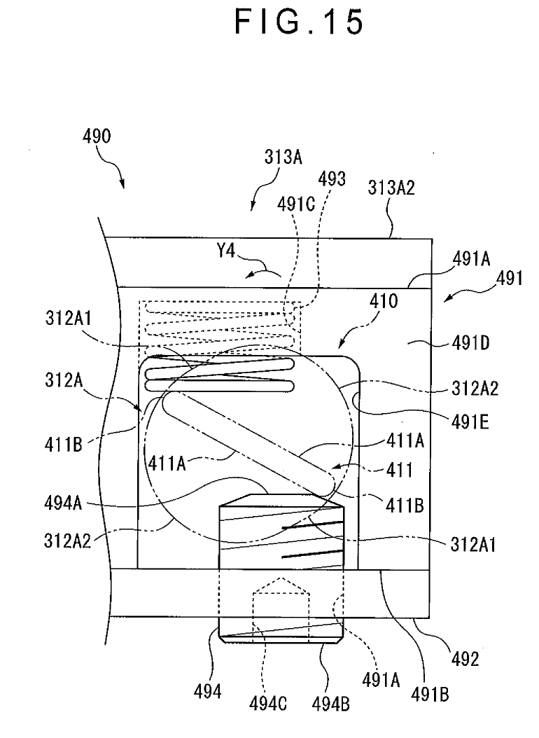

Alternatively, such an arrangement as shown in FIG. 15 may be applied instead of the sub-shaft support 420 of the second exemplary embodiment.

According to the arrangement shown in FIG. 15, a sub-shaft support 490 (guide support) functioning also as the rotation biasing unit of the optical pickup guide device includes. the support base 313A; a support 491; a screw attachment portion 492; a coil spring 493 (biasing member); a setscrew 494 (guide end slide member); and a support body (not shown) to which the sub-shaft end projecting portion 312B of the sub-shaft portion 410 is rotatably engaged.

The support 491 is a substantially rectangular block member. In the support 491, a spring fitting groove 491C is provided in a vicinity of a first attachment surface 491A attached to the first projection 313A2.

On a lateral surface 491D of the support 491 adjacent to the second projection 313A3 (not shown), a shaft inserting opening 491E is provided from a second attachment surface 491B opposing the first attachment surface 491A toward the vicinity of the first attachment surface 491A. The shaft inserting opening 491E has a width slightly larger than a longitudinal dimension of the biasing-side end projecting portion 411 and a diameter of the spring fitting groove 491C. The center of the width of the shaft inserting opening 491E is positioned on the right side of an axis of the spring fitting groove 491C in FIG. 15 (the lateral side view).

A screw attachment portion 492 is a plate member and is provided on a second attachment surface 491B of the support 491. A screw hole 492A is provided on the screw attachment portion 492. The screw attachment portion 492 is attached to, for example, the support 491 in such a manner that the center of the screw hole 492A is positioned on the right side of the center of the width of the shaft inserting opening 491E in FIG. 15, in other words, that the center of the screw hole 492A is not aligned with the center of the spring fitting groove 491C.

The coil spring 493 is fitted in the spring fitting groove 491C of the support 491 and is adapted to be in contact with a proximity of the first semicircular portion 411B of the biasing-side end projecting portion 411.

The setscrew 494 is arranged similarly to the setscrew 313J. The setscrew 494 includes a tip-end 494A, a base end surface 494B, a wrench engagement groove 494C and the like. The setscrew 494 is screwed into the screw hole 492A of the screw attachment portion 492 and is adapted to be in contact with a proximity of the second semicircular portion 411B of the biasing-side end projecting portion 411.

The sub-shaft end projecting portion 312B is engaged with the support body and the biasing-side end projecting portion 411 is positioned between the coil spring 493 and the setscrew 494, whereby the sub-shaft portion 410 can be rotatably supported by the sub-shaft support 490. At this time, the first semicircular portion 411B of the biasing-side end projecting portion 411 is abutted on the coil spring 493 and the second semicircular portion 411B is abutted on the setscrew 494.

Thus, when the sub-shaft portion 410 is supported by the sub-shaft support 490, the first semicircular portion 411B is biased to be moved downward by the coil spring 493. When the first semicircular portion 411B is further moved downward, the second semicircular portion 411B is moved in the right direction in FIG. 15 while being slidably abutted on the tip-end 494A of the setscrew 494, whereby the biasing-side end projecting portion 411 and the sub-shaft 312A start rotating in a direction of Y4 (shown by an arrow) and keep rotating until the circumference of the sub-shaft 312A is abutted on the pair of the sub-shaft slide surfaces 324A21 (the support end state).

Even with this arrangement, the same advantages as those of the second exemplary embodiment described above can be obtained.

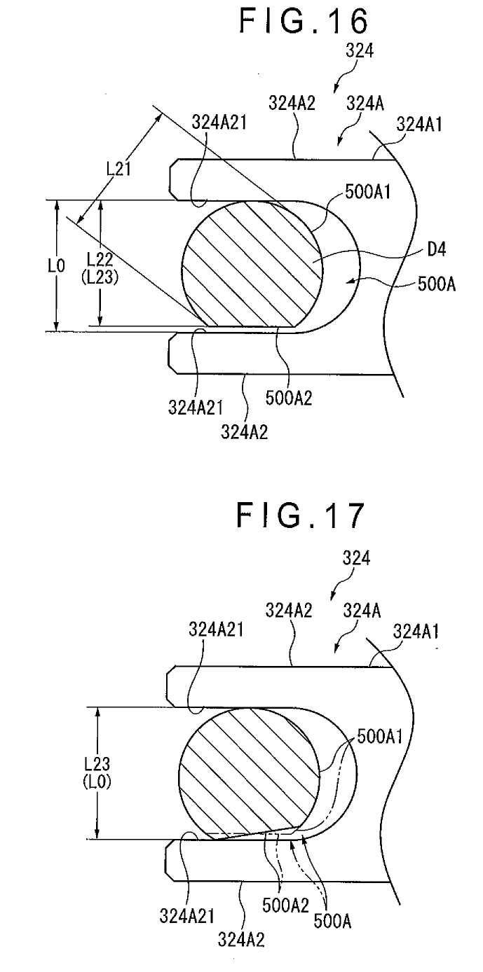

Alternatively, a sub-shaft 500A as a guide member as shown in FIG. 16 may be applied instead of the sub-shaft 312A of the first and second exemplary embodiments or the aforementioned modifications.

As shown in FIG. 16, the sub-shaft 500A is a substantially stick member having a cross section D4 substantially in a D-shape orthogonal to the axis thereof. A maximum external diameter L21 of the cross section D4 is larger than a slide-surface distance L0 and a minimum external diameter L22 is smaller than the slide-surface distance L0. Specifically, the cross section D4 of the sub-shaft 500A includes. an arc portion 500A1 of an obtuse center angle; and a straight portion 500A2 that connects both ends of the arc portion 500A1, thus exhibiting the D-shape cross section.

After the sub-shaft 500A is supported in the support initial state where an opposing-portion distance L23 is equal to a minimum external diameter L22 as shown in FIG. 16, the sub-shaft 500A is rotated until the support end state where the opposing-portion distance L23 is equal to the slide-surface distance L0 as shown in FIG. 17.

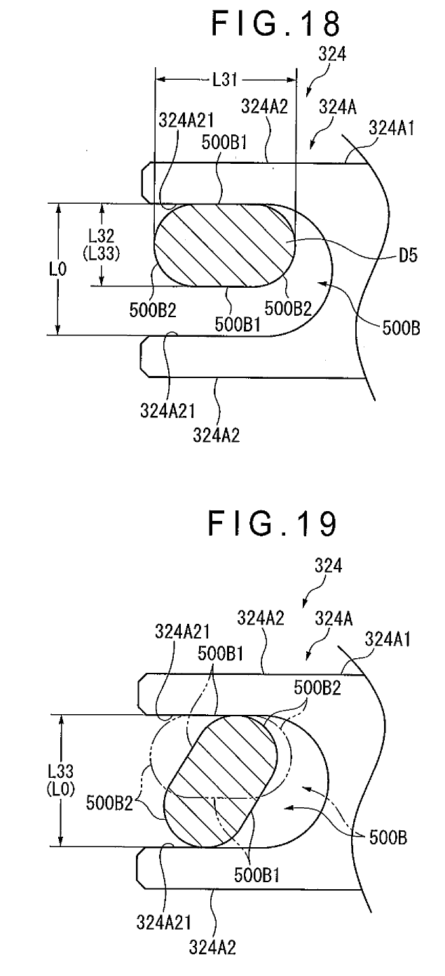

Alternatively, as shown in FIG. 18, a sub-shaft 500B may be applied as a guide member.

As shown in FIG. 18, the sub-shaft 500B is provided by a substantially ellipsoidal stick provided with a cross section D5 orthogonal to the axis thereof the cross section D5 being thinner than the cross section D1 of the sub-shaft 312A. Specifically, a maximum external diameter L31 of the cross section D5 is larger than the slide-surface distance L0 and a minimum external diameter L32 is smaller than the slide-surface distance L0. The cross section D5 includes. a pair of straight portions 500B1 opposing each other at a distance shorter than that of the straight portions 312A1; and semicircular portions 500B2 opposing each other provided on both ends of the straight portions 500B1 and having a diameter smaller than that of the semicircular portions 312A2, thus providing the substantially ellipsoidal.

After the sub-shaft 500B is supported in the support initial state where an opposing-portion distance L33 is equal to a minimum external diameter L32 as shown in FIG. 18, the sub-shaft 500A is rotated until the support end state where the opposing-portion distance L33 is equal to the slide-surface distance L0 as shown in FIG. 19.

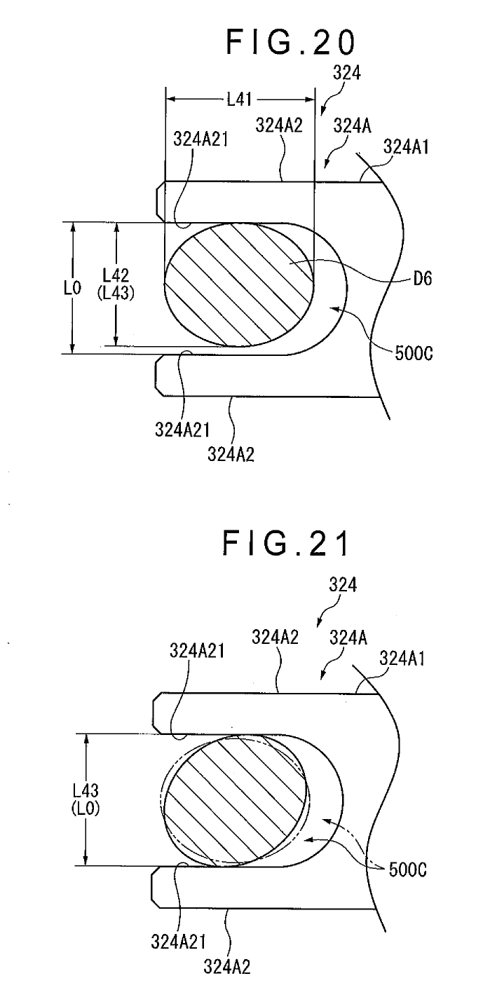

Alternatively, as shown in FIG. 20, a sub-shaft 500C may be applied as a guide member.

As shown in FIG. 20, the sub-shaft 500C is a stick provided with an ellipsoidal cross section D6 orthogonal to an axis of the sub-shaft 312A. A maximum external diameter L41 of the cross section D6 is larger than the slide-surface distance L0 and a minimum external diameter L42 is smaller than the slide-surface distance L0.

After the sub-shaft 500C is supported in the support initial state where an opposing-portion distance L43 is equal to a minimum external diameter L42 as shown in FIG. 20, the sub-shaft 500C is rotated until the support end state where the opposing-portion distance L43 is equal to the slide-surface distance L0 as shown in FIG. 21.

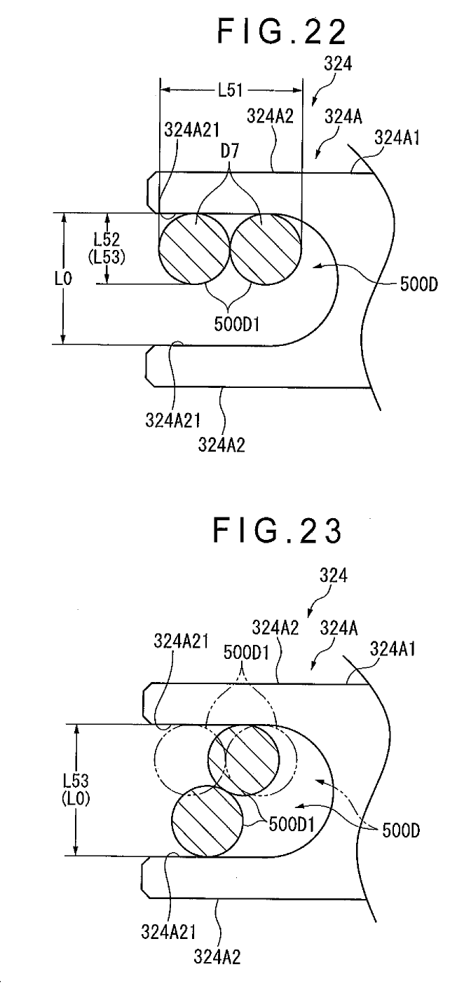

Alternatively, as shown in FIG. 22, a sub-shaft 500D may be applied as a guide member.

As shown in FIG. 22, the sub-shaft 500D includes two round shaft members 500D1, each of which is a stick having a perfect circular cross section D7 orthogonal to an axis thereof. The round shaft members 500D1 are axially parallel to each other and are fixed with each other so that respective circumferences are abutted. By this fixed round shaft members 500D1, a maximum external diameter L51 of the sub-shaft 500D is larger than the slide-surface distance L0 and a minimum external diameter L52 is smaller than the slide-surface distance L0.

After the sub-shaft 500D is supported in the support initial state where the opposing-portion distance L53 is equal to the minimum external diameter L52 as shown in FIG. 22, the sub-shaft 500D is rotated until the support end state where the opposing-portion distance L53 is equal to the slide-surface distance L0 as shown in FIG. 23.

By applying these sub-shafts 500A, 500B, 500C and 500D, the same advantages as those of the first and second exemplary embodiments described above can be also obtained.

Further, with the use of the sub-shaft 500C having the ellipsoidal cross section D6, a circumference of the sub-shaft 500C to be abutted on the sub-shaft slide surface 324A21 is arranged only with curved surfaces. Accordingly the sub-shaft 500C can be abutted on the sub-shaft slide surface 324A21 with the curved surfaces in the support initial state. Consequently, as compared with the sub-shafts 312A, 500A and 500B whose flat surfaces are abutted on the sub-shaft slide surface 324A21 in the support initial state, the sub-shaft 500C can be easily rotated.

Further, when the sub-shaft 500D is applied, the sub-shaft 500D can be easily manufactured by fixing the round shaft members 500D1, which are more easily manufactured than, for example, the sub-shaft 312A of non-perfect circular cross section D1.

The cross section 312A may be alternatively shaped in a polygon such as a triangle and a quadrangle.

Specific configurations and processes when implementing the invention may be other configurations or the like as long as an object of the present invention can be attained.

### Advantages of Exemplary Embodiments

As described above, in the above exemplary embodiments, the disc device 100 includes. the sub-shaft 312A; the sub-shaft support 313 for supporting the sub-shaft 312A; the holder body 321 for holding the optical pickup 330; and a pair of engagement slide portions 324A2 provided in the holder body 321, where the sub-shaft slide surfaces 324A21 are opposed to each other. Further, the cross section D1 of the sub-shaft 312A is provided in a shape other than a perfect circle with a maximum external diameter L11 larger than the slide-surface distance L0, whereby the sub-shaft 312A is rotatably supported by the sub-shaft support 313.

Accordingly as described above, after the sub-shaft 312A is engaged with the shaft engagement portion 324A in order to provide the gap K from the sub-shaft slide surface 324A21, the sub-shaft 312A is rotated until the sub-shaft 312A is not rotatable any more, so that the gap K can be eliminated. Accordingly, the holder body 321 for holding the optical pickup 330 does not require any dedicated arrangement in order to avoid the shaky movement in the direction orthogonal to the moving direction of the pickup holder 320 as in the typical devices, so that a weight and size of the pickup holder 320 are not increased. Consequently, the optical pickup 330 can be appropriately guided without being influenced.

Since the disc device 100 is arranged so as to appropriately guide the optical pickup 330 as described above, a distance between the pickup lens 331 and the optical disc can be appropriately kept to carry out an appropriate information processing.

Further, in manufacturing the moving processing section 310, the sub-shaft 312A is shaped to have the cross section D1 of non-perfect circular shapes and a maximum external diameter L11 larger than the slide-surface distance L0. The sub-shaft 312A is interposed between the shaft engagement portions 324A and is rotatably supported by the sub-shaft support 313 (the support initial state). Subsequently, the sub-shaft 312A is rotated to the rotatable limit to eliminate the gap K (support end state).

Accordingly, the pickup holder 320 does not accompany increase in weight and size of the pickup holder 320 as in the typical arrangement in order to avoid the shaky movement. Consequently the processor moving portion 310 for appropriately guiding the optical pickup 330 without causing adverse effect on the guidance of the optical pickup 330 can be manufactured.

### INDUSTRIAL APPLICABILITY

The invention is applicable to an optical pickup guide device for guiding an optical pickup, a method for manufacturing the same, and a disc device.

1. An optical pickup guide device for guiding an optical pickup substantially along a radial direction of a disc-shaped recording medium held in a recording medium holder, the optical pickup guide device comprising:
a guide comprising a guide member provided in a substantially stick-shaped profile;
a guide support that supports the guide member of the guide;
a holder body that holds the optical pickup and is movable in a guiding direction of the optical pickup in accordance with driving of a moving unit; and
a pair of guide member slide portions provided in the holder body, the guide member slide portions comprising guide member slide surfaces that are slidably in contact with a circumference of the guide member when the holder body is moved, the guide member slide surfaces substantially opposing each other through the guide member, wherein the guide member is provided substantially by a stick whose cross section orthogonal to an axis exhibits a shape other than a perfect circle and has a maximum external diameter larger than a distance between the substantially opposing guide member slide surfaces, the guide member being rotatably supported by the guide support around the axis between the pair of guide member slide portions.

2. The optical pickup guide device according to claim 1, wherein
the guide member is provided substantially in the stick-shaped profile whose cross section orthogonal to the axis is ellipsoidal.

3. The optical pickup guide device according to claim 1, wherein
the guide member is provided substantially in the stick-shaped profile by a plurality of round shaft members fixed axially parallel to each other, the cross section orthogonal to the axis of each of the round shaft members being a perfect circle.

4. The optical pickup guide device according to claim 1, further comprising:
an operation member integrated with the guide member, the operation member being operated when the guide member is rotated.

5. The optical pickup guide device according to claim 1, further comprising:
a rotation biasing unit that biases the guide member to be rotated.

6. The optical pickup guide device according to claim 5, wherein
the guide is provided with a guide end projecting portion projecting in an axial direction of the guide member from at least one end of the guide member, the guide end projecting portion being provided substantially as a stick having a cross section of a shape other than a perfect circle orthogonal to an axis thereof;
the rotation biasing unit includes:
a guide end slide member provided at a position adapted to be in slidable contact with a circumference of the guide end projecting portion; and
a biasing member that is positioned substantially opposing the guide end slide member and that biases the circumference of the guide end projecting portion toward the guide end slide member and simultaneously rotates the guide end projecting portion while being slidably contacted on the guide end slide member.

7. The optical pickup guide device according to claim 5, wherein
the rotation biasing unit includes:
a guide end slide member provided at a position adapted to be in slidable contact with a circumference of a vicinity of at least one end of the guide member; and
a biasing member that is provided at a position substantially opposing the guide end slide member and that biases the circumference of the guide member toward the guide end slide member to rotate the guide member while being in slidable contact with the guide end slide member.

8. The optical pickup guide device according to claim 6, wherein
the biasing member is a spring.

9. The optical pickup guide device according to claim 6, wherein
the rotation biasing unit includes an intermediate member that is interposed between the biasing member and the circumference and is movable toward and away from the guide end slide member while being abutted on the biasing member and the circumference.

10. A disc device, comprising:
a case that houses a disc-shaped recording medium;
a recording medium holder that is provided on the case in a vicinity of a position where the recoding medium is housed and holds the recording medium;
an optical pickup;
the optical pickup guide device according to claim 1 that guides the optical pickup substantially along a radial direction of the recording medium held by the recording medium holder; and
a moving unit that moves the holder body of the optical pickup guide device in a guiding direction of the optical pickup.

11. A method for manufacturing an optical pickup guide device for guiding an optical pickup substantially along a radial direction of a disc-shaped recording medium held in a recording medium holder, the optical pickup guide device comprising:
a guide comprising a guide member provided in a substantially stick-shaped profile;
a guide support that supports the guide member of the guide;
a holder body that holds the optical pickup and is movable in a guiding direction of the optical pickup in accordance with driving of a moving unit; and
a pair of guide member slide portions that are provided in the holder body with guide member slide surfaces that are in slidable contact with a circumference of the guide member when the holder body is moved, the guide member slide surfaces substantially opposing each other through the guide member, the method comprising:
providing the guide member in the substantially stick-shaped profile whose cross section orthogonal to an axis thereof is a shape other than a perfect circle and has a maximum external diameter larger than a distance between guide member slide surfaces of the pair of the guide member slide portions;
rotatably supporting the guide member by the guide support around the axis between the pair of the guide member slide portions; and
rotating the guide member until the guide member is not rotatable where a circumference of the guide member is abutted on the substantially opposing guide member slide surfaces.

12. The optical pickup guide device according to claim 7, wherein
the biasing member is a spring.

13. The optical pickup guide device according to claim 7, wherein
the rotation biasing unit includes an intermediate member that is interposed between the biasing member and the circumference and is movable toward and away from the guide end slide member while being abutted on the biasing member and the circumference.
